(19) United States
(12) Patent Application Publication
(10) Pub. No.: US 2008/0242779 A1
(43) Pub. Date: Oct. 2, 2008

(54) RESINOUS COMPOSITIONS AND ARTICLES MADE THEREFROM

(76) Inventors: Satish Kumar Gaggar, Parkersburg, WV (US); Patricia Bin Sun, Parkersburg, WV (US); Dominique Daniel Arnould, Steenbergseweg (NL); Franciscus Maria Huijs, Breda (NL)

Correspondence Address: SABIC- ESR;SABIC Innovative Plastics - IP Legal, ONE PLASTICS AVENUE, PITTSFIELD, MA, 01201-3697, US

(21) Appl. No.: 11/695,098

(22) Filed: Apr. 2, 2007

(51) Int. Cl. C08L 33/02

(52) U.S. Cl. 524/261; 524/487

(57) ABSTRACT

Disclosed is an article having reduced susceptibility to mar and scratch formation during abrasion of its surface, wherein the article is derived from a composition comprising: (i) at least one rubber modified thermoplastic resin; (ii) a second rigid thermoplastic polymer present in a range of between about 10 wt. % and about 80 wt. %, based on the weight of resinous components in the composition; and (iii) at least one additive selected from the group consisting of (a) a silicone oil and (b) a hydrocarbon wax, said additive being present in an amount in a range of about 0.3 parts per hundred parts resin (phr) to about 3 phr.

### BACKGROUND

The present invention relates to resinous compositions and articles made therefrom having reduced susceptibility to mar and scratch formation on the surface of the articles. In particular embodiments the present invention relates to articles made from compositions comprising (i) a rubber modified thermoplastic resin comprising a discontinuous elastomeric phase dispersed in a rigid thermoplastic phase, wherein at least a portion of the rigid thermoplastic phase is grafted to the elastomeric phase; and (ii) an additive which provides for improved mar and scratch resistance under abrasive conditions in articles made from the compositions.

Rubber modified thermoplastic resins such as acrylonitrile-styrene-acrylate (ASA) and acrylonitrile-butadiene-styrene (ABS) graft copolymers and their blends are typically subject to abrasive environments such as when the materials are used as a cap-stock over a different thermoplastic resin such as poly(vinyl chloride) (PVC) or when the materials are in the form of unitary articles. For example, surface damage to molded parts may occur during shipping and handling due to relatively low mar and scratch resistance of the rubber modified thermoplastic resin surface and the abrasion between the surface and a cardboard container. Also, the surface of rubber modified thermoplastic resins used in exterior automotive applications may undergo abrasive conditions such as during car wash or through surface contact with hard objects.

Due to their better mar/scratch resistance and weatherability, acrylate materials such as poly(methyl methacrylate) (PMMA) are popular choices for molded parts which exhibit good surface appearance retention after abrasion. However, chipping and cracking of brittle acrylic materials significantly affects their yield and productivity during common process steps such as cutting. There is a need for developing materials based on rubber modified thermoplastic resins possessing good mar and scratch resistance and a balance of other beneficial properties.

### BRIEF DESCRIPTION

The present inventors have discovered a method for reducing susceptibility to mar and scratch formation on the surface of resinous compositions which results in benefits such as better durability during shipping and handling of molded parts of the compositions. In one embodiment the present invention comprises an article having reduced susceptibility to mar and scratch formation during abrasion of its surface, wherein the article is derived from a composition comprising (i) at least one rubber modified thermoplastic resin comprising a discontinuous elastomeric phase dispersed in a first rigid thermoplastic phase, wherein at least a portion of the first rigid thermoplastic phase is grafted to the elastomeric phase, and wherein the elastomeric phase comprises structural units derived from a monomer selected from the group consisting of butyl acrylate and butadiene; and wherein the first rigid thermoplastic phase comprises structural units derived from at least two monomers selected from the group consisting of vinyl aromatic monomers, monoethylenically unsaturated nitrile monomers, and (C₁-C₁₂)alkyl- and aryl-(meth)acrylate monomers; (ii) a second rigid thermoplastic polymer comprising (I) bisphenol-A polycarbonate, (II) a polymer with structural units derived from monomers selected from the group consisting of (a) styrene/acrylonitrile; (b) alpha-methylstyrene/acrylonitrile; (c) alpha-methylstyrene/styrene/acrylonitrile; (d) styrene/acrylonitrile/methyl methacrylate; (e) alpha-methyl styrene/acrylonitrile/methyl methacrylate; and (f) alpha-methylstyrene/styrene/acrylonitrile/methyl; methacrylate; (III) poly(methyl methacrylate), or (IV) mixtures thereof, wherein said second rigid thermoplastic polymer is present in a range of between about 10 wt. % and about 80 wt. %, based on the weight of resinous components in the composition; and (iii) at least one additive selected from the group consisting of (a) a silicone oil and (b) a hydrocarbon wax, said additive being present in an amount in a range of about 0.3 parts per hundred parts resin (phr) to about 3 phr.

In another embodiment the present invention comprises an article having reduced susceptibility to mar and scratch formation during abrasion of its surface, wherein the article is derived from a composition comprising: (i) at least one rubber modified thermoplastic resin comprising a discontinuous elastomeric phase comprising structural units derived from butyl acrylate dispersed in a first rigid thermoplastic phase comprising structural units derived from styrene and acrylonitrile or from styrene, acrylonitrile, and methyl methacrylate, wherein at least a portion of the first rigid thermoplastic phase is grafted to the elastomeric phase; (ii) a second rigid thermoplastic polymer selected from the group consisting of a polymer with structural units derived from monomers selected from the group consisting of (a) styrene/acrylonitrile; (b) alpha-methylstyrene/acrylonitrile; (c) alpha-methylstyrene/styrene/acrylonitrile; (d) styrene/acrylonitrile/methyl methacrylate; (e) alpha-methyl styrene/acrylonitrile/methyl methacrylate; (f) alpha-methylstyrene/styrene/acrylonitrile/methyl methacrylate; and (g) mixtures thereof, wherein said second rigid thermoplastic polymer is present in a range of between about 10 wt. % and about 80 wt. %, based on the weight of resinous components in the composition; and (iii) at least one additive selected from the group consisting of (a) a silicone oil and (b) a hydrocarbon wax, said additive being present in an amount in a range of about 0.3 parts per hundred parts resin (phr) to about 3 phr.

Various other features, aspects, and advantages of the present invention will become more apparent with reference to the following description and appended claims.

### DETAILED DESCRIPTION

In the following specification and the claims which follow, reference will be made to a number of terms which shall be defined to have the following meanings. The singular forms “a”, “an” and “the” include plural referents unless the context clearly dictates otherwise. The terminology “monoethylenically unsaturated” means having a single site of ethylenic unsaturation per molecule. The terminology “polyethylenically unsaturated” means having two or more sites of ethylenic unsaturation per molecule. The terminology “(meth)acrylate” refers collectively to acrylate and methacrylate; for example, the term “(meth)acrylate monomers” refers collectively to acrylate monomers and methacrylate monomers. The term “(meth)acrylamide” refers collectively to acrylamides and methacrylamides.

The term “alkyl” as used in the various embodiments of the present invention is intended to designate linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. Alkyl groups may be saturated or unsaturated, and may comprise, for example, vinyl or allyl. The term “alkyl” also encompasses that alkyl portion of alkoxide groups. In various embodiments normal and branched alkyl radicals are those containing from 1 to about 32 carbon atoms, and include as illustrative non-limiting examples C₁-C₃₂ alkyl (optionally substituted with one or more groups selected from C₁-C₃₂ alkyl, C₃-C₁₅ cycloalkyl or aryl); and C₃-C₁₅ cycloalkyl optionally substituted with one or more groups selected from C₁-C₃₂ alkyl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl. The term “aryl” as used in the various embodiments of the present invention is intended to designate substituted or unsubstituted aryl radicals containing from 6 to 20 ring carbon atoms. Some illustrative non-limiting examples of these aryl radicals include C₆-C₂₀ aryl optionally substituted with one or more groups selected from C₁-C₃₂ alkyl, C₃-C₁₅ cycloalkyl, aryl, and functional groups comprising atoms selected from Groups 15, 16 and 17 of the Periodic Table. Some particular illustrative examples of aryl radicals comprise substituted or unsubstituted phenyl, biphenyl, tolyl, naphthyl and binaphthyl.

Compositions in embodiments of the present invention comprise a rubber modified thermoplastic resin comprising a discontinuous elastomeric phase dispersed in a rigid thermoplastic phase, wherein at least a portion of the rigid thermoplastic phase is grafted to the elastomeric phase. The rubber modified thermoplastic resin employs at least one rubber substrate for grafting. The rubber substrate comprises the discontinuous elastomeric phase of the composition. There is no particular limitation on the rubber substrate provided it is susceptible to grafting by at least a portion of a graftable monomer. In some embodiments suitable rubber substrates comprise dimethyl siloxane/butyl acrylate rubber, or silicone/butyl acrylate composite rubber; polyolefin rubbers such as ethylene-propylene rubber or ethylene-propylene-diene (EPDM) rubber; or silicone rubber polymers such as polymethylsiloxane rubber. The rubber substrate typically has a glass transition temperature, Tg, in one embodiment less than or equal to 25° C., in another embodiment below about 0° C., in another embodiment below about minus 20° C., and in still another embodiment below about minus 30° C. As referred to herein, the Tg of a polymer is the T value of polymer as measured by differential scanning calorimetry (DSC; heating rate 20° C./minute, with the Tg value being determined at the inflection point).

In a one embodiment the elastomeric phase comprises a polymer having structural units derived from one or more unsaturated monomers selected from conjugated diene monomers, non-conjugated diene monomers and (C₁-C₁₂) alkyl (meth)acrylate monomers. Suitable conjugated diene monomers include, but are not limited to, 1,3-butadiene, isoprene, 1,3-heptadiene, methyl-1,3-pentadiene, 2,3-dimethylbutadiene, 2-ethyl-1,3-pentadiene, 1,3-hexadiene, 2,4-hexadiene, dichlorobutadiene, bromobutadiene and dibromobutadiene as well as mixtures of conjugated diene monomers. In a particular embodiment the conjugated diene monomer is 1,3-butadiene. Suitable non-conjugated diene monomers include, but are not limited to, ethylidene norbomene, dicyclopentadiene, hexadiene and phenyl norbornene.

In another embodiment the rubber substrate is derived from polymerization by known methods of at least one monoethylenically unsaturated alkyl(meth)acrylate monomer selected from (C₁-C₁₂)alkyl(meth)acrylate monomers and mixtures comprising at least one of said monomers. As used herein, the terminology “(Cₓ-C_{y})”, as applied to a particular unit, such as, for example, a chemical compound or a chemical substituent group, means having a carbon atom content of from “x” carbon atoms to “y” carbon atoms per such unit. For example, “(C₁-C₁₂)alkyl” means a straight chain, branched or cyclic alkyl substituent group having from 1 to 12 carbon atoms per group. Suitable (C₁-C₁₂)alkyl(meth)acrylate monomers include, but are not limited to, (C₁-C₁₂)alkyl acrylate monomers, illustrative examples of which comprise ethyl acrylate, butyl acrylate, iso-pentyl acrylate, n-hexyl acrylate, and 2-ethyl hexyl acrylate; and their (C₁-C₁₂)alkyl methacrylate analogs, illustrative examples of which comprise methyl methacrylate, ethyl methacrylate, propyl methacrylate, iso-propyl methacrylate, butyl methacrylate, hexyl methacrylate, and decyl methacrylate. In a particular embodiment of the present invention the rubber substrate comprises structural units derived from n-butyl acrylate.

In various embodiments the rubber substrate may also optionally comprise a minor amount, for example up to about 5 wt. %, of structural units derived from at least one polyethylenically unsaturated monomer, for example those that are copolymerizable with a monomer used to prepare the rubber substrate. A polyethylenically unsaturated monomer is often employed to provide cross-linking of the rubber particles and/or to provide “graftlinking” sites in the rubber substrate for subsequent reaction with grafting monomers. Suitable polyethylenically unsaturated monomers include, but are not limited to, butylene diacrylate, divinyl benzene, butene diol dimethacrylate, trimethylolpropane tri(meth)acrylate, allyl methacrylate, diallyl methacrylate, diallyl maleate, diallyl fumarate, diallyl phthalate, triallyl methacrylate, triallyl cyanurate, triallyl isocyanurate, the acrylate of tricyclodecenylalcohol and mixtures comprising at least one of such monomers. In a particular embodiment the rubber substrate comprises structural units derived from triallyl cyanurate.

In some embodiments the rubber substrate may optionally comprise structural units derived from minor amounts of other unsaturated monomers, for example up to about 25 percent by weight (“wt. %”) of structural units derived from one or more monomers selected from (C₂-C₈)olefin monomers, vinyl aromatic monomers and monoethylenically unsaturated nitrile monomers. As used herein, the term “(C₂-C₈)olefin monomers” means a compound having from 2 to 8 carbon atoms per molecule and having a single site of ethylenic unsaturation per molecule. Suitable (C₂-C₈)olefin monomers include, e.g., ethylene, propene, 1-butene, 1-pentene, heptene. In other particular embodiments the rubber substrate may optionally include up to about 25 wt. % of structural units derived from one or more monomers selected from (meth)acrylate monomers, alkenyl aromatic monomers and monoethylenically unsaturated nitrile monomers. Suitable copolymerizable (meth)acrylate monomers include, but are not limited to, C₁-C₁₂ aryl or haloaryl substituted acrylate, C₁-C₁₂ aryl or haloaryl substituted methacrylate, or mixtures thereof, monoethylenically unsaturated carboxylic acids, such as, for example, acrylic acid, methacrylic acid and itaconic acid; glycidyl(meth)acrylate, hydroxy alkyl(meth)acrylate, hydroxy(C₁-C₁₂)alkyl(meth)acrylate, such as, for example, hydroxyethyl methacrylate; (C₄-C₁₂)cycloalkyl(meth)acrylate monomers, such as, for example, cyclohexyl methacrylate; (meth)acrylamide monomers, such as, for example, acrylamide, methacrylamide and N-substituted-acrylamide or N-substituted-methacrylamides; maleimide monomers, such as, for example, maleimide, N-alkyl maleimides, N-aryl maleimides, N-phenyl maleimide, and haloaryl substituted maleimides; maleic anhydride; methyl vinyl ether, ethyl vinyl ether, and vinyl esters, such as, for example, vinyl acetate and vinyl propionate. Suitable alkenyl aromatic monomers include, but are not limited to, vinyl aromatic monomers, such as, for example, styrene and substituted styrenes having one or more alkyl, alkoxy, hydroxy or halo substituent groups attached to the aromatic ring, including, but not limited to, alpha-methyl styrene, p-methyl styrene, 3,5-diethylstyrene, 4-n-propylstyrene, 4-isopropylstyrene, vinyl toluene, alpha-methyl vinyl toluene, vinyl xylene, trimethyl styrene, butyl styrene, t-butyl styrene, chlorostyrene, alpha-chlorostyrene, dichlorostyrene, tetrachlorostyrene, bromostyrene, alpha-bromostyrene, dibromostyrene, p-hydroxystyrene, p-acetoxystyrene, methoxystyrene and vinyl-substituted condensed aromatic ring structures, such as, for example, vinyl naphthalene, vinyl anthracene, as well as mixtures of vinyl aromatic monomers and monoethylenically unsaturated nitrile monomers such as, for example, acrylonitrile, ethacrylonitrile, methacrylonitrile, alpha-bromoacrylonitrile and alpha-chloro acrylonitrile. Substituted styrenes with mixtures of substituents on the aromatic ring are also suitable. As used herein, the term “monoethylenically unsaturated nitrile monomer” means an acyclic compound that includes a single nitrile group and a single site of ethylenic unsaturation per molecule and includes, but is not limited to, acrylonitrile, methacrylonitrile, alpha-chloro acrylonitrile, and the like.

In a particular embodiment the elastomeric phase comprises from 60 to 100 wt. % repeating units derived from one or more conjugated diene monomers and from 0 to 40 wt. % repeating units derived from one or more monomers selected from vinyl aromatic monomers and monoethylenically unsaturated nitrile monomers, such as, for example, a styrene-butadiene copolymer, an acrylonitrile-butadiene copolymer or a styrene-butadiene-acrylonitrile copolymer. In another particular embodiment the elastomeric phase comprises from 70 to 90 wt. % repeating units derived from one or more conjugated diene monomers and from 30 to 10 wt. % repeating units derived from one or more monomers selected from vinyl aromatic monomers. In another particular embodiment the rubber substrate comprises repeating units derived from one or more (C₁-C₁₂)alkyl acrylate monomers. In still another particular embodiment, the rubber substrate comprises from 40 to 95 wt. % repeating units derived from one or more (C₁-C₁₂)alkyl acrylate monomers, and more preferably from one or more monomers selected from ethyl acrylate, butyl acrylate and n-hexyl acrylate.

The rubber substrate may be present in the rubber modified thermoplastic resin in one embodiment at a level of from about 4 wt. % to about 94 wt. %; in another embodiment at a level of from about 10 wt. % to about 80 wt. %; in another embodiment at a level of from about 15 wt. % to about 80 wt. %; in another embodiment at a level of from about 35 wt. % to about 80 wt. %; in another embodiment at a level of from about 40 wt. % to about 80 wt. %; in another embodiment at a level of from about 25 wt. % to about 60 wt. %, and in still another embodiment at a level of from about 40 wt. % to about 50 wt. %, based on the weight of the rubber modified thermoplastic resin. In other embodiments the rubber substrate may be present in the rubber modified thermoplastic resin at a level of from about 5 wt. % to about 50 wt. %; at a level of from about 8 wt. % to about 40 wt. %; or at a level of from about 10 wt. % to about 30 wt. %, based on the weight of the particular rubber modified thermoplastic resin.

There is no particular limitation on the particle size distribution of the rubber substrate (sometimes referred to hereinafter as initial rubber substrate to distinguish it from the rubber substrate following grafting). In some embodiments the initial rubber substrate may possess a broad, essentially monomodal, particle size distribution with particles ranging in size from about 50 nanometers (nm) to about 1000 nm, and more particularly with particles ranging in size from about 200 nm to about 500 nm. In other embodiments the mean particle size of the initial rubber substrate may be less than about 100 nm. In still other embodiments the mean particle size of the initial rubber substrate may be in a range of between about 80 nm and about 400 nm. In other embodiments the mean particle size of the initial rubber substrate may be greater than about 400 nm. In still other embodiments the mean particle size of the initial rubber substrate may be in a range of between about 400 nm and about 750 nm. In still other embodiments the initial rubber substrate comprises particles which are a mixture of particle sizes with at least two mean particle size distributions. In a particular embodiment the initial rubber substrate comprises a mixture of particle sizes with each mean particle size distribution in a range of between about 80 nm and about 750 nm. In another particular embodiment the initial rubber substrate comprises a mixture of particle sizes, one with a mean particle size distribution in a range of between about 80 nm and about 400 nm; and one with a broad and essentially monomodal mean particle size distribution.

The rubber substrate may be made according to known methods, such as, but not limited to, a bulk, solution, or emulsion process. In one non-limiting embodiment the rubber substrate is made by aqueous emulsion polymerization in the presence of a free radical initiator, e.g., an azonitrile initiator, an organic peroxide initiator, a persulfate initiator or a redox initiator system, and, optionally, in the presence of a chain transfer agent, e.g., an alkyl mercaptan, to form particles of rubber substrate.

The rigid thermoplastic resin phase of the rubber modified thermoplastic resin, sometimes referred to hereinafter as the first rigid thermoplastic phase, comprises one or more thermoplastic polymers. In one embodiment of the present invention monomers are polymerized in the presence of the rubber substrate to thereby form the first rigid thermoplastic phase, at least a portion of which is chemically grafted to the elastomeric phase. The portion of the first rigid thermoplastic phase chemically grafted to rubber substrate is sometimes referred to hereinafter as grafted copolymer. In some embodiments two or more different rubber substrates, each possessing a different mean particle size, may be separately employed in a polymerization reaction to prepare the first rigid thermoplastic phase, and then the products blended together to make the rubber modified thermoplastic resin. In illustrative embodiments wherein such products each possessing a different mean particle size of initial rubber substrate are blended together, then the ratios of said substrates may be in a range of about 90:10 to about 10:90, or in a range of about 80:20 to about 20:80, or in a range of about 70:30 to about 30:70. In some embodiments an initial rubber substrate with smaller particle size is the major component in such a blend containing more than one particle size of initial rubber substrate.

The first rigid thermoplastic phase comprises a thermoplastic polymer or copolymer that exhibits a glass transition temperature (Tg) in one embodiment of greater than about 25° C., in another embodiment of greater than or equal to 90° C., and in still another embodiment of greater than or equal to 100° C. In a particular embodiment the first rigid thermoplastic phase comprises a polymer having structural units derived from one or more monomers selected from the group consisting of (C₁-C₁₂)alkyl-(meth)acrylate monomers, aryl-(meth)acrylate monomers, alkenyl aromatic monomers and monoethylenically unsaturated nitrile monomers. Suitable (C₁-C₁₂)alkyl-(meth)acrylate and aryl-(meth)acrylate monomers, alkenyl aromatic monomers and monoethylenically unsaturated nitrile monomers include those set forth hereinabove in the description of the rubber substrate. In addition, the first rigid thermoplastic resin phase may, provided that the Tg limitation for the phase is satisfied, optionally include up to about 10 wt. % of third repeating units derived from one or more other copolymerizable monomers.

The first rigid thermoplastic phase typically comprises one or more alkenyl aromatic polymers. Suitable alkenyl aromatic polymers comprise at least about 20 wt. % structural units derived from one or more alkenyl aromatic monomers. In one embodiment the first rigid thermoplastic phase comprises an alkenyl aromatic polymer having structural units derived from one or more alkenyl aromatic monomers and from one or more monoethylenically unsaturated nitrile monomers. Examples of such alkenyl aromatic polymers include, but are not limited to, styrene/acrylonitrile copolymers, alpha-methylstyrene/acrylonitrile copolymers, or alpha-methylstyrene/styrene/acrylonitrile copolymers. In another particular embodiment the first rigid thermoplastic phase comprises an alkenyl aromatic polymer having structural units derived from one or more alkenyl aromatic monomers; from one or more monoethylenically unsaturated nitrile monomers; and from one or more monomers selected from the group consisting of (C₁-C₁₂)alkyl- and aryl-(meth)acrylate monomers. Examples of such alkenyl aromatic polymers include, but are not limited to, styrene/acrylonitrile/methyl methacrylate copolymers, alpha-methylstyrene/acrylonitrile/methyl methacrylate copolymers and alpha-methylstyrene/styrene/acrylonitrile/methyl methacrylate copolymers. Further examples of suitable alkenyl aromatic polymers comprise styrene/methyl methacrylate copolymers, styrene/maleic anhydride copolymers; styrene/acrylonitrile/maleic anhydride copolymers, and styrene/acrylonitrile/acrylic acid copolymers. These copolymers may be used for the first rigid thermoplastic phase either individually or as mixtures.

When structural units in copolymers are derived from one or more monoethylenically unsaturated nitrile monomers, then the amount of nitrile monomer added to form the copolymer comprising the grafted copolymer and the first rigid thermoplastic phase may be in one embodiment in a range of between about 5 wt. % and about 40 wt. %, in another embodiment in a range of between about 5 wt. % and about 30 wt. %, in another embodiment in a range of between about 10 wt. % and about 30 wt. %, and in yet another embodiment in a range of between about 15 wt. % and about 30 wt. %, based on the total weight of monomers added to form the copolymer comprising the grafted copolymer and the first rigid thermoplastic phase.

When structural units in copolymers are derived from one or more (C₁-C₁₂)alkyl- or aryl-(meth)acrylate monomers, then the amount of the said monomer added to form the copolymer comprising the grafted copolymer and the first rigid thermoplastic phase may be in one embodiment in a range of between about 5 wt. % and about 50 wt. %, in another embodiment in a range of between about 5 wt. % and about 45 wt. %, in another embodiment in a range of between about 10 wt. % and about 35 wt. %, and in yet another embodiment in a range of between about 15 wt. % and about 35 wt. %, based on the total weight of monomers added to form the copolymer comprising the grafted copolymer and the first rigid thermoplastic phase.

The first rigid thermoplastic resin phase of the rubber modified thermoplastic resin may, provided that the Tg limitation for the phase is satisfied, optionally include up to about 10 wt. % of repeating units derived from one or more other copolymerizable monomers such as, e.g., monoethylenically unsaturated carboxylic acids such as, e.g., acrylic acid, methacrylic acid, itaconic acid, hydroxy(C₁-C₁₂)alkyl (meth)acrylate monomers such as, e.g., hydroxyethyl methacrylate; (C₄-C₁₂)cycloalkyl(meth)acrylate monomers such as e.g., cyclohexyl methacrylate; (meth)acrylamide monomers such as e.g., acrylamide and methacrylamide; maleimide monomers such as, e.g., N-alkyl maleimides, N-aryl maleimides, maleic anhydride, vinyl esters such as, e.g., vinyl acetate and vinyl propionate. As used herein, the term “(C₄-C₁₂)cycloalkyl” means a cyclic alkyl substituent group having from 4 to 12 carbon atoms per group.

The amount of grafting that takes place between the rubber substrate and monomers comprising the first rigid thermoplastic phase varies with the relative amount and composition of the rubber substrate. In one embodiment, greater than about 10 wt. % of the first rigid thermoplastic phase is chemically grafted to the rubber substrate, based on the total amount of first rigid thermoplastic phase in the composition. In another embodiment, greater than about 15 wt. % of the first rigid thermoplastic phase is chemically grafted to the rubber substrate, based on the total amount of first rigid thermoplastic phase in the composition. In still another embodiment, greater than about 20 wt. % of the first rigid thermoplastic phase is chemically grafted to the rubber substrate, based on the total amount of first rigid thermoplastic phase in the composition. In particular embodiments the amount of first rigid thermoplastic phase chemically grafted to the rubber substrate may be in a range of between about 5 wt. % and about 90 wt. %; between about 10 wt. % and about 90 wt. %; between about 15 wt. % and about 85 wt. %; between about 15 wt. % and about 50 wt. %; or between about 20 wt. % and about 50 wt. %, based on the total amount of first rigid thermoplastic phase in the composition. In yet other embodiments, about 40 wt. % to 90 wt. % of the first rigid thermoplastic phase is free, that is, non-grafted.

Rigid thermoplastic phase in compositions of the invention may be formed solely by polymerization carried out in the presence of rubber substrate, or by addition of one or more separately synthesized rigid thermoplastic polymers to the rubber modified thermoplastic resin comprising the composition, or by a combination of both processes. Any separately synthesized rigid thermoplastic polymers are sometimes referred to hereinafter as second rigid thermoplastic polymer. In some embodiments the second rigid thermoplastic polymer comprises structural units essentially identical to those of the first rigid thermoplastic phase comprising the rubber modified thermoplastic resin. In some particular embodiments the second rigid thermoplastic polymer comprises structural units derived from (a) styrene and acrylonitrile; (b) alpha-methylstyrene and acrylonitrile; (c) alpha-methylstyrene, styrene, and acrylonitrile; (d) styrene, acrylonitrile, and methyl methacrylate; (e) alpha-methyl styrene, acrylonitrile, and methyl methacrylate; or (f) alpha-methylstyrene, styrene, acrylonitrile, and methyl methacrylate. In other particular embodiments the second rigid thermoplastic polymer comprises at least one polycarbonate, and in particular at least one bisphenol-A polycarbonate. In still other particular embodiments the second rigid thermoplastic polymer comprises at least two bisphenol-A polycarbonates having different molecular weights. In still other particular embodiments the second rigid thermoplastic polymer comprises poly(methyl methacrylate). Mixtures comprising at least two second rigid thermoplastic polymers may also be employed. When at least a portion of second rigid thermoplastic polymer is added to the rubber modified thermoplastic resin, then the amount of said separately synthesized rigid thermoplastic polymer added is in one embodiment in a range of between about 5 wt. % and about 90 wt. %, in another embodiment in a range of between about 5 wt. % and about 80 wt. %, in another embodiment in a range of between about 10 wt. % and about 80 wt. %, in another embodiment in a range of between about 10 wt. % and about 70 wt. %, in another embodiment in a range of between about 15 wt. % and about 65 wt. %, and in still another embodiment in a range of between about 20 wt. % and about 65 wt. %, based on the weight of resinous components in the composition. In some particular embodiments wherein the second rigid thermoplastic polymer comprises a polycarbonate, the amount of said second rigid thermoplastic polymer present in the compositions is in one embodiment in a range of 25-90 wt. %, in another embodiment in a range of 30-45 wt. % and in still another particular embodiment in a range of 60-80 wt. %, based on the weight of resinous components in the composition. Although typically the elastomeric phase of the rubber modified thermoplastic resin is dispersed in the first rigid thermoplastic phase, those skilled in the art will recognize that a portion of said elastomeric phase may optionally be dispersed in the second rigid thermoplastic polymer or in a mixture of first rigid thermoplastic phase and second rigid thermoplastic polymer.

The total rigid thermoplastic phase may be present in the rubber modified thermoplastic resin in one embodiment at a level of from about 85 wt. % to about 6 wt. %; in another embodiment at a level of from about 65 wt. % to about 6 wt. %; in another embodiment at a level of from about 60 wt. % to about 20 wt. %; in another embodiment at a level of from about 75 wt. % to about 40 wt. %, and in still another embodiment at a level of from about 60 wt. % to about 50 wt. %, based on the weight of the rubber modified thermoplastic resin. In other embodiments the rigid thermoplastic phase may be present in a range of between about 90 wt. % and about 30 wt. %, based on the weight of the rubber modified thermoplastic resin.

Both first rigid thermoplastic phase and second rigid thermoplastic polymer may be made according to known processes, for example, mass polymerization, emulsion polymerization, suspension polymerization or combinations thereof, wherein at least a portion of the rigid thermoplastic phase is chemically bonded, i.e., “grafted” to the rubber substrate via reaction with unsaturated sites present in the rubber substrate in the case of the first rigid thermoplastic phase. The grafting reaction may be performed in a batch, continuous or semi-continuous process. Representative procedures include, but are not limited to, those taught in U.S. Pat. No. 3,944,631. The unsaturated sites in the rubber substrate are provided, for example, by residual unsaturated sites in those structural units of the rubber that were derived from a graftlinking monomer. In some embodiments of the present invention monomer grafting to rubber substrate with concomitant formation of rigid thermoplastic phase may optionally be performed in stages wherein at least one first monomer is grafted to rubber substrate followed by at least one second monomer different from said first monomer. Representative procedures for staged monomer grafting to rubber substrate include, but are not limited to, those taught in U.S. Pat. No. 7,049,368.

In a particular embodiment the rubber modified thermoplastic resin is an ABS graft copolymer. In another particular embodiment the rubber modified thermoplastic resin is a polymethacrylate-butadiene-styrene (MBS) copolymer. In still another particular embodiment the rubber modified thermoplastic resin is an ASA graft copolymer such as that manufactured and sold by General Electric Company under the trademark GELOY®, and preferably an acrylate-modified acrylonitrile-styrene-acrylate graft copolymer. ASA polymeric materials include, for example, those disclosed in U.S. Pat. No. 3,711,575. Acrylonitrile-styrene-acrylate graft copolymers include, for example, those described in commonly assigned U.S. Pat. Nos. 4,731,414 and 4,831,079. In some embodiments of the invention where an acrylate-modified ASA is used, the ASA component further comprises an additional acrylate-graft formed from monomers selected from the group consisting of C₁ to C₁₂ alkyl- and aryl-(meth)acrylate as part of either the rigid phase, the elastomeric phase, or both. Such copolymers are referred to as acrylate-modified acrylonitrile-styrene-acrylate graft copolymers, or acrylate-modified ASA. A particular monomer is methyl methacrylate to result in a PMMA-modified ASA (sometimes referred to hereinafter as “MMA-ASA”).

In embodiments of the invention compositions also comprise one or more additives which alone or together may serve to reduce or eliminate susceptibility to mar and scratch formation on the surface of articles made from the compositions. Suitable additives comprise at least one additives selected from the group consisting of a silicone oil and a hydrocarbon wax. Silicone oils suitable for use in compositions of the invention comprise those with a kinematic viscosity in a range of between about 0.2 centimeters squared per second (cm²/s) and about 150 cm²/s in one embodiment; in a range of between about 0.4 cm²/s and about 120 cm²/s in another embodiment; and in a range of between about 0.5 cm²/s and about 100 cm²/s in still another embodiment. Silicone oils are available from numerous sources, for example, from General Electric, Wacker Silicones and Dow Corning. In a particular embodiment a suitable silicone oil comprises at least one polydimethylsiloxane. In another particular embodiment a suitable silicone oil consists essentially of at least one polydimethylsiloxane. In still another particular embodiment a suitable silicone oil consists of polydimethylsiloxane.

Hydrocarbon waxes suitable for use in compositions of the invention comprise non-polar paraffin waxes, for example, those comprising about C₁₈ to about C₇₀ carbon units; and polyolefin waxes, for example, those comprising about C₁₀₀-C₇₀₀ carbon units. In particular embodiments suitable waxes comprise polyethylene waxes, such as low density polyethylene wax (LDPE) or high density polyethylene wax (HDPE) with molecular weights in a range of about 1,000-10,000; polypropylene wax; and natural and synthetic paraffin waxes such as those produced by a Fischer-Tropsch process. In other particular embodiments suitable hydrocarbon waxes comprise non-normal hydrocarbon waxes comprising hydrocarbons with molecules containing a chain of carbon atoms which is not entirely straight, but which may include one or more of the following features: (a) branched carbon chains (i.e. side-chains of carbon atoms attached to the main chain); (b) naphthene ring structures (i.e. cycloparaffinic rings; rings of saturated carbon atoms containing no double bonding); or (c) aromatic ring structures. Some illustrative examples of suitable hydrocarbon waxes include, but are not limited to, those supplied by Clariant under the tradename LICOLUB®. Mixtures comprising at least one silicone oil and at least one hydrocarbon wax may also be employed.

Suitable silicone oil and/or hydrocarbon wax additives may be present in compositions of the invention in an amount effective to reduce or eliminate susceptibility to mar and scratch formation on the surface of articles made from the compositions. In particular embodiments said additive may be present in compositions of the invention in an amount in a range of between about 0.1 parts per hundred parts resin (phr) and about 3 phr, or in an amount in a range of between about 0.2 phr and about 3 phr, or in an amount in a range of between about 0.3 phr and about 3 phr, or in an amount in a range of between about 0.3 phr and about 2 phr, or in an amount in a range of between about 0.3 phr and about 1 phr.

A silicone oil or hydrocarbon wax may also be included in compositions of the invention either in essentially undiluted form or in the form of a masterbatch prepared by pre-combination of silicone oil or hydrocarbon wax with a resinous material, such as, but not limited to a rubber modified thermoplastic resin such as one or more of those described herein above, or a thermoplastic polyolefin. In some embodiments the masterbatch is prepared in an extrusion process. The amount of silicone oil or hydrocarbon wax in the masterbatch is in one embodiment in a range of 20-60 wt. %, and in another embodiment in a range of 30-50 wt. % based on the weight of the masterbatch.

Compositions of the present invention may also optionally comprise additives known in the art including, but not limited to, stabilizers, such as color stabilizers, heat stabilizers, light stabilizers, antioxidants, UV screeners, and UV absorbers; flame retardants, anti-drip agents, lubricants, flow promoters and other processing aids; plasticizers, antistatic agents, mold release agents, impact modifiers, fillers, and colorants such as dyes or pigments which may be organic, inorganic or organometallic; and like additives. Illustrative additives include, but are not limited to, silica, silicates, zeolites, titanium dioxide, stone powder, glass fibers or spheres, carbon fibers, carbon black, graphite, calcium carbonate, talc, lithopone, zinc oxide, zirconium silicate, iron oxides, diatomaceous earth, calcium carbonate, magnesium oxide, chromic oxide, zirconium oxide, aluminum oxide, crushed quartz, clay, calcined clay, talc, kaolin, asbestos, cellulose, wood flour, cork, cotton or synthetic textile fibers, especially reinforcing fillers such as glass fibers, carbon fibers, metal fibers, and metal flakes, including, but not limited to aluminum flakes. Often more than one additive is included in compositions of the invention, and in some embodiments more than one additive of one type is included. In a particular embodiment a composition further comprises an additive selected from the group consisting of colorants, dyes, pigments, lubricants, stabilizers, heat stabilizers, light stabilizers, antioxidants, UV screeners, UV absorbers, fillers and mixtures thereof

Compositions of the invention and articles made therefrom may be prepared by known thermoplastic processing techniques. Known thermoplastic processing techniques which may be used include, but are not limited to, extrusion, calendering, kneading, profile extrusion, sheet extrusion, pipe extrusion, coextrusion, molding, extrusion blow molding, thermoforming, injection molding, co-injection molding, rotomolding, combinations of such processes, and like processes.

The invention further contemplates additional fabrication operations on said articles, such as, but not limited to, in-mold decoration, baking in a paint oven, surface etching, lamination, and/or thermoforming. In a particular embodiment compositions of the invention may be employed in a profile extrusion process. In other particular embodiments compositions of the invention can be extruded to make sheet, pipe or profile with excellent appearance using general extrusion lines equipped with calibrators at normal production speed.

Compositions of the present invention have reduced susceptibility to mar and scratch formation on the surface of articles made from the compositions. Reduced susceptibility to mar and scratch formation may be obtained in some embodiments by adjusting the ratio between the rubber modified thermoplastic resin and one or more of the required additives. Optimized ratios may be readily determined by those skilled in the art without undue experimentation. In a particular embodiment compositions of the invention exhibit reduced susceptibility to mar and scratch formation on the surface of articles made from the compositions as measured using the test procedure as described herein below. In another particular embodiment the surface of articles made from compositions of the invention comprising at least one of a silicone oil or hydrocarbon wax additive exhibit improved % gloss retention in abrasion testing compared to the surface of articles made from compositions not containing at least one of a silicone oil or hydrocarbon wax additive. Compositions of the invention comprising at least one of a silicone oil or hydrocarbon wax additive exhibit in one embodiment at least 80% gloss retention, in another embodiment at least 85% gloss retention, and in still another embodiment at least 95% gloss retention after 1000 abrasion test cycles. In still other embodiments the surface of articles made from compositions of the invention comprising at least one of a silicone oil or hydrocarbon wax additive exhibit at least 10% higher % gloss retention after 1000 abrasion test cycles compared to the surface of articles made from compositions not containing at least one of a silicone oil or hydrocarbon wax additive.

The compositions of the present invention can be formed into useful articles. In some embodiments the articles comprise unitary articles. Illustrative unitary articles comprise a profile consisting essentially of a composition of the present invention. In still other embodiments the articles may comprise multilayer articles comprising at least one layer comprising a composition of the present invention. In various embodiments multilayer articles may comprise a cap-layer comprising a composition of the invention and a substrate layer comprising at least one thermoplastic resin different from said cap-layer. In some particular embodiments said substrate layer comprises at least one of an acrylic polymer; PMMA; a rubber-modified acrylic polymer; rubber-modified PMMA; ASA; poly(vinyl chloride) (PVC); acrylonitrile-butadiene-styrene copolymer (ABS); polycarbonate (PC); or mixtures comprising at least one of the aforementioned materials, including, but not limited to, mixtures of ASA and PC; mixtures of ABS and PC; mixtures of ABS and an acrylic polymer; and mixtures of ABS and PMMA. In some particular embodiments PC consists essentially of at least one bisphenol-A polycarbonate. Additional illustrative examples of resins suitable for substrate layers comprise polyesters, such as, but not limited to, poly(alkylene terephthalates), poly(alkylene naphthalates), poly(ethylene terephthalate), poly(butylene terephthalate), poly(trimethylene terephthalate), poly(ethylene naphthalate), poly(butylene naphthalate), poly(cyclohexanedimethanol terephthalate), poly(cyclohexanedimethanol-co-ethylene terephthalate), poly(1,4-cyclohexane-dimethyl-1,4-cyclohexanedicarboxylate), polyarylates, the polyarylate with structural units derived from resorcinol and a mixture of iso- and terephthalic acids, polyestercarbonates, the polyestercarbonate with structural units derived from bisphenol-A, carbonic acid and a mixture of iso- and terephthalic acids, the polyestercarbonate with structural units derived from resorcinol, carbonic acid and a mixture of iso- and terephthalic acids, and the polyestercarbonate with structural units derived from bisphenol-A, resorcinol, carbonic acid and a mixture of iso- and terephthalic acids. Additional illustrative examples of resins suitable for substrate layers further comprise aromatic polyethers such as polyarylene ether homopolymers and copolymers such as those comprising 2,6-dimethyl-1,4-phenylene ether units, optionally in combination with 2,3,6-trimethyl-1,4-phenylene ether units; polyetherimides, polyetherketones, polyetheretherketones, polyethersulfones; polyarylene sulfides and sulfones, such as polyphenylene sulfides, polyphenylene sulfones, and copolymers of polyphenylene sulfides with polyphenylene sulfones; polyamides, such as poly(hexamethylene adipamide) and poly(ε-aminocaproamide); polyolefin homopolymers and copolymers, such as polyethylene, polypropylene, and copolymers containing at least one of ethylene and propylene; polyacrylates, poly(methyl methacrylate), poly(ethylene-co-acrylate)s including SURLYN®; polystyrene, syndiotactic polystyrene, poly(styrene-co-acrylonitrile), poly(styrene-co-maleic anhydride); and compatibilized blends comprising at least one of any of the aforementioned resins, such as thermoplastic polyolefin (TPO); poly(phenylene ether)-polystyrene, poly(phenylene ether)-polyamide, poly(phenylene ether)-polyester, poly(butylene terephthalate)-polycarbonate, poly(ethylene terephthalate)-polycarbonate, polycarbonate-polyetherimide, and polyester-polyetherimide. Suitable substrate layers may comprise recycled or reground thermoplastic resin. In addition in some embodiments said multilayer article may comprise at least one substrate layer and at least one tielayer between said substrate layer and said cap-layer. Multilayer articles comprising a cap-layer comprised of a composition of the present invention may exhibit reduced susceptibility to mar and scratch formation on the surface of said articles compared to similar articles without said cap-layer.

Applications for articles comprising compositions of the present invention include, but are not limited to, sheet, pipe capstock, hollow tubes, solid round stock, square cross-section stock, and the like. More complex shapes can also be made, such as those used for building and construction applications, especially a window frame, a sash door frame, pricing channels, corner guards, house siding, gutters, handrails, down-spouts, fence posts, and the like. Additional illustrative applications comprise exterior automotive parts, interior automotive parts, appliance housings and parts, TV parts, TV bezels and the like.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

In the following examples resinous components are expressed in wt. %. Non-resinous components are expressed in phr. ASA-1 was an acrylonitrile-styrene-acrylate copolymer with structural units derived from about 40-45% butyl acrylate, about 35-40% styrene, and about 15-20% acrylonitrile having broad monomodal rubber particle size distribution. The types of MMA-ASA employed were MMA-ASA-1, a copolymer comprising structural units derived from 28-34 wt. % styrene, 10-15 wt. % acrylonitrile, 10-15 wt. % methyl methacrylate, and about 40-45 wt. % butyl acrylate with broad monomodal rubber particle size distribution; MMA-ASA-2, a copolymer comprising structural units derived from 30-35 wt. % styrene, 10-15 wt. % acrylonitrile, 5-10 wt. % methyl methacrylate, and about 40-45 wt. % butyl acrylate with narrow rubber particle size distribution of about 110 nanometers (nm); MMA-ASA-3, a copolymer comprising structural units derived from 30-35 wt. % styrene, 10-15 wt. % acrylonitrile, 5-10 wt. % methyl methacrylate, and about 40-45 wt. % butyl acrylate with narrow rubber particle size distribution of about 500 nm; and MMA-ASA-4, a mixture of copolymers comprising about 3 parts by weight MMA-ASA-2 and about 1 part by weight MMA-ASA-3. The types of MMASAN employed were MMASAN-1, a copolymer comprising structural units derived from about 30-35 wt. % methyl methacrylate, about 35-40 wt. % styrene and about 20-25 wt. % acrylonitrile and having a weight average molecular weight (Mw) of about 120,000; and MMASAN-2, a copolymer comprising structural units derived from about 30-35 wt. % methyl methacrylate, about 35-40 wt. % styrene and about 20-25 wt. % acrylonitrile and having a weight average molecular weight (Mw) of about 155,000. The types of SAN employed were SAN-1 with structural units derived from about 65-70% styrene and about 30-35% acrylonitrile and having a molecular weight of about 82,000, SAN-2 with structural units derived from about 65-70% styrene and about 30-35% acrylonitrile and having a molecular weight of about 160,000, SAN-3 with structural units derived from about 70-75% styrene and about 25-30% acrylonitrile and having a molecular weight of about 170,000 produced in a bulk process, and SAN-4 with structural units derived from about 70-75% styrene and about 25-30% acrylonitrile and having a molecular weight of about 100,000 produced in a suspension process. AMSAN was poly(alpha-methylstyrene) with structural units derived from about 65-70% alpha-methylstyrene and about 30-35% acrylonitrile and having a molecular weight of about 75,000. PMMA was ACRYLITE® H-12 with Vicat softening point of 105° C. and average melt flow of 7 grams per 10 minutes measured at 230° C. and 3.8 kilograms obtained from CRYO Industries. Silicone oils employed were silicone oil-1, a poly(dimethyl siloxane) having a nominal viscosity of about 10 centimeters squared per second (cm²/s) measured at 25° C., silicone oil-2, a poly(dimethyl siloxane) having a nominal viscosity of about 0.5 cm²/s measured at 25° C., silicone oil-3, a poly(dimethyl siloxane) having a nominal viscosity of about 1 cm²/s measured at 25° C., and silicone oil-4, a poly(dimethyl siloxane) having a nominal viscosity of about 100 cm²/s measured at 25° C. In addition a masterbatch (referred to herein after as “Si MB”) was prepared in pellet form comprising 40% organo-modified siloxane and 60% polyolefin. Hydrocarbon wax (abbreviated “Hydrocarb. wax”) was LICOLUB® H4 non-polar modified hydrocarbon wax, obtained from Clariant and having a drop point of about 110° C. (ASTM D127) and both an acid value and a saponification value of about zero mg. KOH per gram. Unless noted, all of the compositions comprised 1 phr ethylene bis-stearamide (EBS) wax and 1.9 phr of a mixture comprising hindered phenolic anti-oxidants, ultraviolet light absorbers, and phosphorus-comprising stabilizers. All compositions were compounded into pellets and then injection molded into test plaques either with dimensions of about 10.2 cm.×about 15.2 cm. or grained test plaques with dimensions of about 15 cm.×about 20 cm. To minimize the effect of molding on surface morphology and thus the mar resistance results, all samples were prepared under the same molding conditions and only the center part of the plaques was used for gloss measurements.

Mar testing was performed on an MTS mechanical tester under cyclic mode of testing. Test specimens were pin loaded and attached to the moving crosshead of the machine. Two flexible strips of metal were attached to the upper grip of the machine with a spacer to allow test specimens to slide between the strips. Inside of each metal strip was attached the abrading media using a double sticking tape. A spring clamp was used on the metal strips for providing normal load. Felt fabric was used as a relatively mild abrasive medium. A typical cardboard material was used for more aggressive abrasion. In a typical experiment the upper grip of the machine was attached to a load cell and load was continuously monitored using a digital oscilloscope. Measured tangential load value is related to normal force through the coefficient of friction of the sample. Specimen width was about 1.9 centimeters (cm) and length about 12.7 cm. In the test procedure the initial surface gloss at 60 degrees was measured for each specimen and then compared with the gloss after a predetermined number of abrasion cycles. Gloss was measured according to ASTM D523 taking 10 measurements across the width of a test part at 5 locations along the length of said test part. Values for gloss level are presented as the mean value of 50 results. Values are reported as % gloss retention wherein a higher value represents a better resistance to mar formation in abrasion testing. Scratch testing was performed using an automatic scratch test apparatus (model 705 from Sheen Instruments). Scratch and mar resistance may also be measured using a Taber scratch tester or using Chrysler laboratory procedure LP-463PB-54-01. The data for examples and comparative examples presented in each table represent samples tested under the same abrasion conditions. The abbreviation “C. Ex.” means Comparative Example.

### EXAMPLES 1-2 AND COMPARATIVE EXAMPLES 1-3

Compositions were compounded from the components shown in Table 1 and molded into test parts. The test parts were subjected to abrasion testing to induce mar formation. The abrasion test results are shown in Table 1.

TABLE 1

| Component | C. Ex. 1 | C. Ex. 2 | Ex. 1 | C. Ex. 3 | Ex. 2 |
|---|---|---|---|---|---|
| MMA-ASA-1 | 55 | 35 | 35 | — | — |
| MMA-ASA-2 | — | — | — | 23 | 23 |
| MMA-ASA-3 | — | — | — | 12 | 12 |
| MMASAN-1 | — | 65 | 65 | 65 | 65 |
| MMASAN-2 | 45 | — | — | — | |
| Si oil-1 | — | — | 0.5 | — | 0.5 |
| % Gloss | | | | | |
| retention | | | | | |
| after 500 | 66 | 80 | 99 | 94 | 97 |
| cycles | | | | | |
| after 1000 | 46 | 65 | 98 | 88 | 97 |
| cycles | | | | | |

The compositions containing silicone oil showed significantly better gloss retention after abrasion to induce mar formation than did comparative compositions without silicone oil. Also, the composition with lower rubber content (C.Ex. 2) showed better gloss retention after abrasion to induce mar formation than did the comparative composition (C.Ex. 1) with high rubber content. In addition the composition with bimodal rubber particle size (C.Ex. 3) showed better gloss retention after abrasion to induce mar formation than did the comparative composition (C.Ex. 2) with broad monomodal rubber particle size. Both optical microscopy and scanning electron microscopy (SEM) showed that compositions containing silicone oil had more uniform surface characteristics than did comparable samples without silicone oil. An SEM-EDX (energy dispersive x-ray) analysis of a molded test part of Example 1 containing silicone oil showed uniform distribution of silicone through the depth analyzed (100 microns).

### EXAMPLES 3-5 AND COMPARATIVE EXAMPLE 4

Compositions were compounded from the components shown in Table 2 and molded into test parts. The test parts were subjected to abrasion testing to induce mar formation. The abrasion test results are shown in Table 2.

TABLE 2

| Component | C. Ex. 4 | Ex. 3 | Ex. 4 | Ex. 5 |
|---|---|---|---|---|
| MMA-ASA-2 | 24.5 | 24.5 | 24.5 | 24.5 |
| MMA-ASA-3 | 10.5 | 10.5 | 10.5 | 10.5 |
| MMASAN-1 | 65 | 65 | 65 | 65 |
| Si oil-3 | — | 0.2 | 0.5 | 1.0 |
| % Gloss | | | | |
| retention | | | | |
| after 500 | 94 | 101 | 97 | 97 |
| cycles | | | | |
| after 1000 | 88 | 95 | 97 | 98 |
| cycles | | | | |

The compositions containing silicone oil showed significantly better gloss retention after abrasion to induce mar formation than did a comparative composition without silicone oil. In addition, an analysis of friction force versus silicone oil loading showed a decrease in force from 26.6 Newtons to 13.3 Newtons as the amount of silicone oil increased from 0 phr to 1 phr, indicating a decrease in friction on the molded part surface.

### EXAMPLES 6-8 AND COMPARATIVE EXAMPLE 5

Compositions were compounded from the components shown in Table 3 and molded into test parts. The test parts were subjected to abrasion testing to induce mar formation. The abrasion test results are shown in Table 3.

TABLE 3

| | C. Ex. 5 | Ex. 6 | Ex. 7 | Ex. 8 |
|---|---|---|---|---|
| Component | | | | |
| MMA-ASA-2 | 24.5 | 24.5 | 24.5 | 24.5 |
| MMA-ASA-3 | 10.5 | 10.5 | 10.5 | 10.5 |
| MMASAN-1 | 65 | 65 | 65 | 65 |
| Si oil-2 | — | 0.5 | — | — |
| Si oil-3 | — | — | 0.5 | — |
| Si oil-4 | — | — | — | 0.5 |
| % Gloss | | | | |
| retention | | | | |
| after 500 | 94 | 101 | 98 | 97 |
| cycles | | | | |
| after 1000 | 88 | 101 | 98 | 96 |
| cycles | | | | |

The compositions containing silicone oil showed significantly better gloss retention after abrasion to induce mar formation than did a comparative composition without silicone oil.

### EXAMPLES 9-10

Compositions were compounded from the components shown in Table 4 and molded into test parts. The silicone masterbatch provided about 1 phr organo-modified siloxane. The test parts were subjected to abrasion testing to induce mar formation. The abrasion test results are shown in Table 4.

TABLE 4

| Component | Ex. 9 | Ex. 10 |
|---|---|---|
| MMA-ASA-1 | 35 | 35 |
| MMASAN-1 | 65 | 65 |
| Si oil-3 | 0.5 | — |
| Si MB | — | 2.5 |
| % Gloss retention | | |
| after 1000 cycles | 97 | 97 |

The compositions containing silicone oil or organo-modified siloxane showed good gloss retention after abrasion to induce mar formation. Example 10 demonstrates that the additive may be combined with the composition in the form of a masterbatch to obtain good results.

### EXAMPLES 11-14

Compositions were compounded from the components shown in Table 5 and molded into test parts. The test parts were subjected to abrasion testing to induce mar formation. The abrasion test results are shown in Table 5.

TABLE 5

| Component | Ex. 11 | Ex. 12 | Ex. 13 | Ex. 14 |
|---|---|---|---|---|
| MMA-ASA-2 | 24.5 | 24.5 | 24.5 | 24.5 |
| MMA-ASA-3 | 10.5 | 10.5 | 10.5 | 10.5 |
| MMASAN-2 | 65 | — | — | — |
| SAN-1 | — | 65 | — | — |
| SAN-2 | — | — | 65 | — |
| PMMA | — | — | — | 65 |
| Si oil-3 | 0.5 | 0.5 | 0.5 | 0.5 |
| % Gloss | | | | |
| retention | | | | |
| after 500 | 98 | 98 | — | 95 |
| cycles | | | | |
| after 1000 | 98 | 98 | 96 | 95 |
| cycles | | | | |

The data for gloss retention show that a variety of rigid phase materials may be used in the compositions along with silicone oil to obtain good gloss retention after abrasion of test parts to induce mar formation.

### EXAMPLES 15-16 AND COMPARATIVE EXAMPLE 6

Compositions were compounded from the components shown in Table 6 and molded into test parts. The test parts were subjected to abrasion testing to induce mar formation. The abrasion test results are shown in Table 6.

TABLE 6

| Component | C. Ex. 6 | Ex. 15 | Ex. 16 |
|---|---|---|---|
| MMA-ASA-2 | 33 | 33 | 33 |
| MMA-ASA-3 | 12 | 12 | 12 |
| MMASAN-2 | 15 | 15 | 15 |
| AMSAN | 40 | 40 | 40 |
| Si oil-3 | — | 0.5 | — |
| Hydrocarb. wax | — | — | 0.5 |
| % Gloss retention | | | |
| after 500 cycles | 80 | 98 | — |
| after 1000 cycles | 60 | 98 | 87 |
| after 1500 cycles | 32 | 95 | — |
| after 2000 cycles | 29 | 92 | 78 |

The composition containing either silicone oil or hydrocarbon wax showed significantly better gloss retention after abrasion to induce mar formation than did a comparative composition without either silicone oil or hydrocarbon wax.

### EXAMPLE 17 AND COMPARATIVE EXAMPLE 7

Compositions were compounded from the components shown in Table 7 and molded into test parts. The test parts were subjected to abrasion testing to induce mar formation. The abrasion test results are shown in Table 7.

TABLE 7

| Component | C. Ex. 7 | Ex. 17 |
|---|---|---|
| ASA-1 | 35 | 35 |
| SAN-3 | 65 | 65 |
| Si oil-3 | — | 0.4 |
| % Gloss retention | | |
| after 200 cycles | 64 | 90 |
| after 400 cycles | 62 | 91 |
| after 500 cycles | 57 | 84 |

The composition containing silicone oil showed significantly better gloss retention after abrasion to induce mar formation than did a comparative composition without silicone oil.

### EXAMPLES 18-20 AND COMPARATIVE EXAMPLES 8-9

Compositions were compounded from the components shown in Table 8 and molded into test parts. All of the compositions in Table 8 comprised 1 phr ethylene bis-stearamide (EBS) wax and 1.4 phr of a mixture comprising hindered phenolic anti-oxidants, ultraviolet light absorbers, and phosphorus-comprising stabilizers. In addition the composition of Example 20 contained 0.5 phr zinc stearate. The test parts were subjected to abrasion testing to induce mar formation.

TABLE 8

| | C. Ex. 8 | C. Ex. 9 | Ex. 18 | Ex. 19 | Ex. 20 |
|---|---|---|---|---|---|
| ASA-1 | 35 | — | — | — | — |
| MMA-ASA-1 | — | 35 | — | — | — |
| MMA-ASA-4 | | | 35 | 35 | 35 |
| SAN-3 | 65 | — | — | — | — |
| MMASAN-2 | — | 65 | 65 | 65 | 35 |
| AMSAN | — | — | — | — | 30 |
| Si oil-3 | — | — | 0.5 | — | 0.5 |
| Hydrocarb. wax | — | — | — | 2 | — |
| % Gloss | | | | | |
| retention | | | | | |
| after 1000 | 86 | 88 | 99 | 100 | 103 |
| cycles | | | | | |
| after 2000 | 78 | 83 | 99 | 100 | 103 |
| cycles | | | | | |

Compositions containing either silicone oil or hydrocarbon wax showed significantly better gloss retention after abrasion to induce mar formation than did comparative compositions without either silicone oil or hydrocarbon wax.

### EXAMPLES 21-25 AND COMPARATIVE EXAMPLE 10

Compositions were compounded from the components shown in Table 9 and molded into test parts. All of the compositions in Table 9 further comprised a mixture of additives and aluminum flake pigment. The test parts were subjected to abrasion testing to induce mar formation.

TABLE 9

| | C. Ex. 10 | Ex. 21 | Ex. 22 | Ex. 23 | Ex. 24 | Ex. 25 |
|---|---|---|---|---|---|---|
| MMA- | 45 | 45 | 45 | 45 | 45 | 45 |
| ASA-4 | | | | | | |
| AMSAN | 55 | 55 | 55 | 55 | 55 | 55 |
| Si oil-1 | — | — | — | — | 0.5 | 3 |
| Hydrocarb. | — | 0.5 | 2 | 3 | — | — |
| wax | | | | | | |
| % Gloss | | | | | | |
| retention | | | | | | |
| after 1000 | 75 | 87 | 80 | 75 | 96 | 110 |
| cycles | | | | | | |
| after 2000 | 68 | 78 | 74 | 74 | 93 | 111 |
| cycles | | | | | | |

Compositions containing either silicone oil or hydrocarbon wax showed better gloss retention after abrasion to induce mar formation than did a comparative composition without either silicone oil or hydrocarbon wax.

### EXAMPLES 26-31 AND COMPARATIVE EXAMPLE 11

Compositions were compounded from the components shown in Table 10 and molded into test parts. All of the compositions in Table 10 further comprised a mixture of additives and aluminum flake pigment. The test parts were subjected to scratch testing.

TABLE 10

| | C. Ex. | Ex. | Ex. | Ex. | | | |
|---|---|---|---|---|---|---|---|
| | 11 | 26 | 27 | 28 | Ex. 29 | Ex. 30 | Ex. 31 |
| MMA- | 45 | 45 | 45 | 45 | 45 | 45 | 45 |
| ASA-4 | | | | | | | |
| AMSAN | 55 | 55 | 55 | 55 | 55 | 55 | 55 |
| Si oil-1 | — | — | — | — | — | 0.5 | 3 |
| Hydrocarb. | — | 0.5 | 1 | 2 | 3 | — | — |
| wax | | | | | | | |
| Scratch test | | | | | | | |
| Pass/Fail | Fail | Fail | Pass | Pass | Pass | Fail | Pass |
| 100 g. | | | | | | | |
| Pass/Fail | Fail | Fail | Fail | Pass | Pass | Fail | Pass |
| 200 g. | | | | | | | |

Compositions containing either silicone oil or hydrocarbon wax showed better scratch resistance than did a comparative composition without either silicone oil or hydrocarbon wax.

### EXAMPLE 32 AND COMPARATIVE EXAMPLE 12

Compositions are compounded from the components comprising acrylonitrile-butadiene-styrene (ABS) resin either with or without an effective amount of silicone oil. The compositions are molded into test parts and the test parts are subjected to abrasion testing to induce mar formation. The composition containing silicone oil shows significantly better gloss retention after abrasion to induce mar formation than does the comparative composition without silicone oil.

### EXAMPLE 33 AND COMPARATIVE EXAMPLE 13

Compositions are compounded from the components comprising 25-90 wt. % of a bisphenol-A polycarbonate and either ABS or ASA molded into test parts. Compositions are prepared with and without an effective amount of silicone oil. The compositions are molded into test parts and the parts are subjected to abrasion testing to induce mar formation. The compositions containing silicone oil show significantly better gloss retention after abrasion to induce mar formation than does the comparative composition without silicone oil.

### EXAMPLES 34-35 AND COMPARATIVE EXAMPLE 14

Compositions were compounded from the components shown in Table 11 and molded into test parts. All of the compositions in Table 11 further comprised a mixture of additives including a flame retardant. The test parts were subjected to abrasion testing to induce mar formation.

TABLE 11

| | C. Ex. 14 | Ex. 34 | Ex. 35 |
|---|---|---|---|
| ASA-1 | 10 | 10 | 10 |
| PC | 86 | 86 | 86 |
| SAN-4 | 4 | 4 | 4 |
| Si oil-1 | — | 0.4 | — |
| Hydrocarb. wax | — | — | 0.4 |
| % Gloss | | | |
| retention | | | |
| after 100 cycles | 59 | 92 | 91 |
| after 200 cycles | 55 | 84 | 84 |
| after 300 cycles | 41 | 76 | 74 |
| after 400 cycles | 36 | 69 | 65 |
| after 500 cycles | 28 | 65 | 55 |

The compositions containing silicone oil or hydrocarbon wax show significantly better gloss retention after abrasion to induce mar formation than does a comparative composition without silicone oil or hydrocarbon wax.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. An article having reduced susceptibility to mar and scratch formation during abrasion of its surface, wherein the article is derived from a composition comprising:
(i) at least one rubber modified thermoplastic resin comprising a discontinuous elastomeric phase dispersed in a first rigid thermoplastic phase, wherein at least a portion of the first rigid thermoplastic phase is grafted to the elastomeric phase, and wherein the elastomeric phase comprises structural units derived from a monomer selected from the group consisting of butyl acrylate and butadiene; and wherein the first rigid thermoplastic phase comprises structural units derived from at least one vinyl aromatic monomer, at least one monoethylenically unsaturated nitrile monomer, and optionally at least one (C₁-C₁₂)alkyl- and aryl-(meth)acrylate monomer;
(ii) a second rigid thermoplastic polymer comprising (I) bisphenol-A polycarbonate, (II) a polymer with structural units derived from monomers selected from the group consisting of (a) styrene/acrylonitrile; (b) alpha-methylstyrene/acrylonitrile; (c) alpha-methylstyrene/styrene/acrylonitrile; (d) styrene/acrylonitrile/methyl methacrylate; (e) alpha-methyl styrene/acrylonitrile/methyl methacrylate; and (f) alpha-methylstyrene/styrene/acrylonitrile/methyl methacrylate; (III) poly(methyl methacrylate), or (IV) mixtures thereof, wherein said second rigid thermoplastic polymer is present in a range of between about 10 wt. % and about 80 wt. %, based on the weight of resinous components in the composition; and
(iii) at least one additive selected from the group consisting of (a) a silicone oil and (b) a hydrocarbon wax, said additive being present in an amount in a range of about 0.3 parts per hundred parts resin (phr) to about 3 phr.

2. The article of claim 1, wherein the polymer of the elastomeric phase further comprises structural units derived from at least one polyethylenically unsaturated monomer.

3. The article of claim 2, wherein the polyethylenically unsaturated monomer is selected from the group consisting of butylene diacrylate, divinyl benzene, butene diol dimethacrylate, trimethylolpropane tri(meth)acrylate, allyl methacrylate, diallyl methacrylate, diallyl maleate, diallyl fumarate, diallyl phthalate, triallyl methacrylate, triallyl isocyanurate, triallyl cyanurate, the acrylate of tricyclodecenylalcohol and mixtures thereof.

4. The article of claim 1, wherein the elastomeric phase comprises about 10 wt. % to about 80 wt. % of the rubber modified thermoplastic resin.

5. The article of claim 1, wherein at least about 5 wt. % to about 90 wt. % of rigid thermoplastic phase is chemically grafted to the elastomeric phase, based on the total amount of rigid thermoplastic phase in the composition.

6. The article of claim 1, wherein the first rigid thermoplastic phase comprises structural units derived from styrene and acrylonitrile; or styrene, alpha-methyl styrene, and acrylonitrile; or styrene, acrylonitrile, and methyl methacrylate; or alpha-methyl styrene, acrylonitrile and methyl methacrylate; or styrene, alpha-methyl styrene, acrylonitrile and methyl methacrylate.

7. The article of claim 1, wherein the silicone oil has a kinematic viscosity in a range of between about 0.2 centimeters squared per second (cm²/s) and about 150 cm²/s.

8. The article of claim 1, wherein the silicone oil comprises a polydimethylsiloxane.

9. The article of claim 1, wherein the hydrocarbon wax comprises at least one of a non-polar paraffin wax, a polyolefin wax, a polyethylene wax, a low density polyethylene wax, a high density polyethylene wax, a natural or synthetic paraffin wax, or a wax produced by a Fischer-Tropsch process.

10. The article of claim 1, wherein the silicone oil or hydrocarbon wax is combined with the composition in the form of a masterbatch comprising about 20-60 wt. % of silicone oil or hydrocarbon wax.

11. The article of claim 1, wherein the composition further comprises at least one additive selected from the group consisting of a stabilizer; a color stabilizer; a heat stabilizer; a light stabilizer; an antioxidant; a UV screener; a UV absorber; a flame retardant; an anti-drip agent; a lubricant; a flow promoter; a processing aid; a plasticizer; an antistatic agent; a mold release agent; an impact modifier; a filler; a colorant; a dye; a pigment; and mixtures thereof.

12. The article of claim 1, which is a unitary or a multilayer article.

13. The article of claim 12, which comprises a sheet, pipe capstock, hollow tube, solid round stock, square cross-section stock, building or construction application article, window frame, sash door frame, pricing channel, corner guard, house siding, gutter, handrail, down-spout, fence post, exterior automotive part, interior automotive part, appliance housing or part, TV part, or TV bezel.

14. An article having reduced susceptibility to mar and scratch formation during abrasion of its surface, wherein the article is derived from a composition comprising:
(i) at least one rubber modified thermoplastic resin comprising a discontinuous elastomeric phase comprising structural units derived from butyl acrylate dispersed in a first rigid thermoplastic phase comprising structural units derived from styrene and acrylonitrile or from styrene, acrylonitrile, and methyl methacrylate, wherein at least a portion of the first rigid thermoplastic phase is grafted to the elastomeric phase;
(ii) a second rigid thermoplastic polymer selected from the group consisting of a polymer with structural units derived from monomers selected from the group consisting of (a) styrene/acrylonitrile; (b) alpha-methylstyrene/acrylonitrile; (c) alpha-methylstyrene/styrene/acrylonitrile; (d) styrene/acrylonitrile/methyl methacrylate; (e) alpha-methyl styrene/acrylonitrile/methyl methacrylate; (f) alpha-methylstyrene/styrene/acrylonitrile/methyl methacrylate; and (g) mixtures thereof, wherein said second rigid thermoplastic polymer is present in a range of between about 10 wt. % and about 80 wt. %, based on the weight of resinous components in the composition; and
(iii) at least one additive selected from the group consisting of (a) a silicone oil and (b) a hydrocarbon wax, said additive being present in an amount in a range of about 0.3 parts per hundred parts resin (phr) to about 3 phr.

15. The article of claim 14, wherein the silicone oil is combined with the composition in the form of a masterbatch comprising about 20-60 wt. % of silicone oil.

16. The article of claim 14, wherein the composition further comprises at least one additive selected from the group consisting of a stabilizer; a color stabilizer; a heat stabilizer; a light stabilizer; an antioxidant; a UV screener; a UV absorber; a flame retardant; an anti-drip agent; a lubricant; a flow promoter; a processing aid; a plasticizer; an antistatic agent; a mold release agent; an impact modifier; a filler; a colorant; a dye; a pigment; and mixtures thereof.

17. The article of claim 14, which is a unitary or a multilayer article.

18. The article of claim 17, which comprises a sheet, pipe capstock, hollow tube, solid round stock, square cross-section stock, building or construction application article, window frame, sash door frame, pricing channel, corner guard, house siding, gutter, handrail, down-spout, fence post, exterior automotive part, interior automotive part, appliance housing or part, TV part, or TV bezel.
